(19) United States
(12) Patent Application Publication
(10) Pub. No.: US 2006/0251836 A1
(43) Pub. Date: Nov. 9, 2006

(54) Plastic moulded bodies, method for the production and use thereof

(76) Inventors: Simon Jonas, Hattersheim (DE); Robert W. Fuss, Liederbach (DE); Matthias Gutweiler, Hunfelden-Dauborn (DE); Michael Frank, Russelsheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/544,504

(22) PCT Filed: Feb. 4, 2004
(86) PCT No.: PCT/EP04/00984

§ 371 Date: Jun. 7, 2006

(30) Foreign Application Priority Data
Feb. 4, 2003 (DE) 10304 537.6

(51) Int. Cl. B32B 27/08

(52) U.S. Cl. 428/35.7

(57) ABSTRACT

The invention relates to plastic moulded bodies comprising a substrate layer, a barrier layer and a cover layer. The barrier layer contains polyvinyl alcohol. Said plastic moulded bodies are characterised in that the cover layer comprises compounds which can be cross-linked. The invention also relates to plastic moulded bodies comprising a cross-linked cover layer, a method for the production of the inventive plastic moulded body and the use thereof.

The present invention relates to plastic moulded bodies, processes for their production and their use. In particular, the present invention relates to plastic moulded bodies exhibiting a barrier layer of polyvinyl alcohol and a cover layer which his highly suitable for storing liquids containing carbon dioxide and/or sensitive to oxidation.

The use of weight-reducing packaging, particularly in the field of beverage packaging, is increasing continually and the substitution of glass by plastics, in particular by polyethylene terephthalate (PET) containers, is progressing steadily. However, in order to achieve the properties of glass especially with regard to the gas barrier properties polyethylene terephthalate is satisfactory only if the bottles are correspondingly thick-walled. However, this requires a larger amount of material to be used than would be necessary for static reasons. Apart from involving higher material costs, this has a particularly negative effect at the expense of the desired weight reduction.

For this reason, the use of polyethylene terephthalate containers provided with barrier layers has been suggested in the literature which are to be produced e.g. by means of coextrusion, in the case of which, in the simplest case, a multiple layer sequence, e.g. polyethylene terephthalate (PET)/barrier layer/polyethylene terephthalate (PET) is produced, or by means of plasma-enhanced vapour deposition processes, preferably with aluminium and/or its oxides, silicon and/or its oxides or carbon as primary layer material. Although the gas barrier properties of the containers can in this way, basically, be improved, both procedures are poorly suited for practical application because they are, on the one hand, highly cost-intensive and time-consumung as a result of the high cost price of the required machinery, the limited useful life of the machinery and the high sensitivity of the machinery. Moreover, the mechanical properties of the containers which are achievable in this way are insufficient for day-to-day use. The high mechanical stresses to which the coated containers are subject even during a normal filling and packaging process and even more so during subsequent distribution and in use, frequently lead to impairment of the surface of the barrier layer which in turn drastically reduces the gas barrier effect of the barrier layer.

A first approach to solve these problems is described in the printed document GB 2 337 470 A which proposes reducing the gas permeability of a substrate, such as e.g. a PET bottle, by applying a barrier layer of a first polymer, such as e.g. polyvinyl alcohol, onto the substrate and then protecting the barrier layer against the environment by applying a protective layer of a second polymer with a molecular weight in the region of 5,000 to 50,000 g/mole. As possible materials for the protective layer, polyethylene terephthalate, polyester, polyester copolymers, polycarbonates, polyolefins, PEN, polyvinyl chloride, polyamides, polypropylene, polystyrene, aliphatic polyketones and/or polyethylene are mentioned.

An advantage of this solution is the use of polyvinyl alcohol as barrier polymer since, on the one hand, exhibits excellent gas barrier properties, in particular vis-à-vis carbon dioxide and oxygen. At the same time, polyvinyl alcohol is classified as an environmentally friendly raw material safe for health which can be used for food packaging without reservations. However, it is a disadvantage that the coated PET bottles obtainable according to GB 2 337 470 are still not able to withstand the strong mechanical stresses during the normal filling and packaging process and later during distribution and in use. On the contrary, cracks in the protective layer are frequently observed after only a short time, which cracks lead to either the protective layer, in some cases even including the barrier layer, peeling off partly or completely and/or the barrier layer becoming detached by contact with water such as e.g. water of condensation, water vapour etc., as a result of which the desired barrier effect is almost completely lost.

In view of this state of the art, it was thus the task of the present invention to provide plastic moulded bodies with as low a gas permeability, in particular to oxygen and carbon dioxide, as possible, which moulded bodies simultaneously exhibit as high a mechanical stability and durability as possible such that they withstand the strong mechanical stresses during the normal filling and packaging process and later during distribution and use. In particular, the plastic moulded bodies should exhibit gas barrier properties which are almost unchanged even after prolonged use.

A further task of the invention consisted of indicating plastic moulded bodies which can be used as food packaging without reservations. For this reason, they should consist of materials which are safe for health and environmentally friendly and are preferably recyclable in as simple a manner as possible.

A third task of the invention could be seen in indicating a process for the production of the plastic moulded bodies according to the invention which can be carried out on an industrial scale and cost effectively in as simple a manner as possible. In this context, the use of technically complex equipment was to be avoided as far as possible in order to maximise the useful life of the machinery and to minimise simultaneously the necessary investment and maintenance costs of the machinery. Moreover, the possible fields of application of the plastic moulded bodies according to the invention were to be shown.

Moreover, the plastic moulded bodies should be easy to recycle. In addition, it should be possible to make the plastic moulded body in as high a proportion of one material.

These as well as and other tasks not specifically mentioned, which, however, can be derived or deduced without difficulty from the context discussed herein, are achieved by a plastic moulded bodies plastic moulded body with all the characteristics of patent claims 1. Appropriate modifications of the plastic moulded body according to the invention are protected in the sub-claims which relate to claim 1. The claims of the process category protect particularly advantageous processes for the production of the plastic moulded body according to the invention and the claims of the use category relate to particularly advantageous fields of application of the plastic moulded bodies according to the invention.

By providing a plastic moulded body exhibiting a barrier layer and a cover layer, the barrier layer containing polyvinyl alcohol and the plastic moulded bodies being characterised in that the cover layer comprises compounds which can be cross-linked, it is possible in a manner not or not directly foreseeable to make a plastic moulded body with an extremely low gas permeability especially to oxygen and carbon dioxide accessible which plastic moulded body simultaneously exhibits an extremely high mechanical stability and durability and consequently withstands the strong mechanical stresses during the normal filling and packaging process and later during distribution and use without problems. The formation of cracks in the cover layer or even peeling off of the cover layer is not observed even after prolonged use.

At the same time, the plastic moulded body according to the invention exhibits a number of further advantages. These include among others:
The plastic moulded body according to the invention exhibits barrier properties which are almost unchanged even after prolonged use.
If necessary, the plastic moulded body according to the invention is recyclable in a simple manner on an industrial scale and cost effectively.
The production of the plastic moulded body according to the invention is possible in the simplest manner on an industrial scale and cost effectively. The use of technically complex equipment is not necessary so that the useful life of the machinery can be maximised and the necessary investment and maintenance costs of the machinery simultaneously minimised.
According to a particularly preferred embodiment of the present invention, curing of the cover layer takes place by UV and/or electron radiation. In comparison with the otherwise common processes such as e.g. the application of the cover layer from a solution, this is particularly advantageous since it is possible in this way to work without solvents, among other things, and to avoid the food law problems associated therewith. Further advantages resulting in this way are, among others:
   Curing takes place extremely rapidly in this way and allows rapid further processing of the resulting plastic moulded bodies.
   The energy requirement is considerably lower in comparison with thermal drying processes.
   Heat sensitive materials, too, can be coated without problems.
   Dyes which may be used do not dry onto the auxiliary means used for coating such as pressure rollers, doctor blades etc. This reduces the cleaning effort considerably.
   Radiation curing leads to highly homogeneous and smooth surfaces.
Due to their extremely low permanent gas permeability, in particular to oxygen and carbon dioxide, the plastic moulded body according to the invention is suitable in particular for storing liquids which contain carbon dioxide and/or are sensitive to oxidation, above all beer, tea, fruit juices containing carbon dioxide and other gas-containing and/or oxidation-sensitive beverages (carbonated soft drinks).
The barrier layer and the cover layer can be applied very thinly. Consequently, the plastic moulded body can consist in a high proportion of one plastic material. For this reason, the plastic moulded bodies can be recycled highly economically and easily.

The present invention relates to plastic moulded bodies which preferably consist to an amount, based on their total weight, of at least 80.0% by wt., appropriately at least 90.0% by wt., in particular by at least 95.0% by wt., of plastic. For this purpose—depending on the application—basically all known plastics can be used, the use of thermoplastically processable plastics, in particular of polyethylene terephthalate (PET), however, having proved suitable above all.

Moreover, the plastic moulded body can be both a so-called preform and a finished moulded body that has already been (blow) extruded. The use of a perform, in particular, especially for plastic bottles has the advantage that the coating according to the invention can be applied during the very production thereof and the subsequent use, e.g. in the bottling machines, requires only slight changes to the existing plants.

According to the invention, the plastic moulded body exhibits preferably on its external surface a barrier layer containing polyvinyl alcohol. The polyvinyl alcohol is basically not subject to any further restrictions; instead, all known types pf polyvinyl alcohol can be used. For the purposes of the present invention, however it has proved to be particularly advantageous to use a polyvinyl alcohol which comprises, based on its total weight,
a.) 15.0 to 99.9% by wt., preferably 25.0 to 99.9% by wt., appropriately 40.0 to 99.9% by wt., in particular 50.0 to 99.9% by wt., structural units with the formula (2) 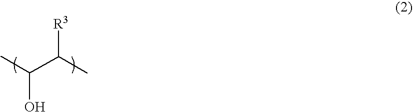
b.) 0.0 to 50.0% by wt., preferably 0.1 to 50.0% by wt. structural units with the formula (3) 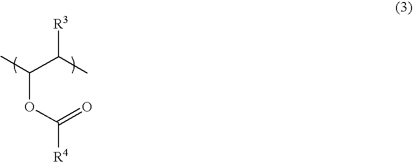
c.) 0.0 to 50.0% by wt. structural units with the formula (4)

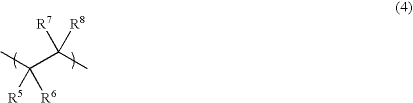

The structural units concerned natural differ from each other; in particular, the structural unit with the general formula/3) does not comprise the structural units with the general formula (2) and/or (3).

The radical R³ represents, independently of each other in each case hydrogen or methyl, preferably hydrogen.

The radical R⁴ characterises an alkyl radical with 1 to 6 carbon atoms, appropriately a methyl, ethyl, n-propel, isopropyl, n-butyl, sec-butyl, tert-butyl, n-pentyl or an n-hexyl group, advantageous a methyl or an ethyl group, in particular a methyl group.

The radicals R⁵, R⁶, R⁷ and R⁸, are independently of each other in each case, radicals with a molecular weight in the region of 1 to 500 g/mole, appropriately hydrogen, an optionally branched aliphatic or cycloaliphatic radical with 1 to 16 carbon atoms which optionally may contain one or several carboxylic acid, carboxylic anhydride, carboxylic acid ester, carboxylic acid amide, silyl and/or sulphonic acid groups.

Particularly preferred structural units with the formula (4) are derived from straight chain or branched olefins with 2 to 18 carbon atoms, (meth)acrylic acid, maleic acid, maleic acid anhydride, fumaric acid, itaconic acid, crotonic acid, (meth)acrylic acid, trialkoxy vinylsilane and/or ethylene sulphonic acid. In this connection, olefins, in particular those with a terminal C-C double bond which preferably exhibit 2 to 6 carbon atoms, in particular ethylene, have proved to be particularly advantageous. Moreover, according to the invention, structural units (4) derived from acrylamide propenyl sulphonic acid (AMPS) lead to particularly advantageous results.

The total number of structural units with the formula (3) is preferably in the region of 0.1 to 50% by mole, preferably in the region of 0.1 to 30% by mole, appropriately in the region of 0.1 to 20% by mole, in particular in the region of 0.1 to 16% by mole, based on the total number of structural units with the formula (2) and (3) in each case. Particularly advantageous results can be observed within the framework of the present invention for a total number of structural units with the formulae (3) in the region of 0.3 to 13% by mole, in particular in the region of 0.5 to 10% by mole, based on the total number of structural units with the formula (2) and (3).

The total number of structural units with the formula (4) is preferably in the region of in the region of 0.1 to 20% by mole, appropriately in the region of 2 to 19% by mole, in particular in the region of 2.5 to 17% by mole, based on the total number of structural units with the formula (2), (3) and (4). Particularly advantageous results can be achieved within the framework of the present invention for a total number of structural units with the formula (4) in the region of 3.0 to 15% by mole, in particular in the region of 3.5 to 13% by mole, based on the total number of structural units with the formulae (2), (3) and (4).

Within the framework of a particular embodiment of the present invention, an ethylene vinyl alcohol copolymer with 1 to 19% by mole, preferably 2 to 10% by mole, of units (4) derived from ethylene, and 75 to 99% by mole, preferably 90 to 98% by mole, of units (2), R¹ being hydrogen (4), based on the content of units (2), (3) and (4), is used as polyvinyl alcohol in each case. Such copolymers are commercially available e.g. under the trade name Exceval®.

According to the invention, the polyvinyl alcohol preferably contains, based on its total weight in each case, preferably >60% by wt., advantageous >70% by wt., in particular >80% by wt. structural units with the formula (2) and/or (3). Particularly advantageous results can in this case be obtained with polyvinyl alcohols which, based on their total weight in each case, contain >85% by wt., appropriately >90% by wt., advantageous>95% by wt., in particular >99% by wt. structural units with the formula (2) and/or (3).

Within the task of the present invention, the polyvinyl alcohol may posses a syndiotactic, isotactic and/or atactic chain structure. Moreover, it can optionally be present both as a random and as a block copolymer.

The production of these polyvinyl alcohols can take place in a two-stage process in a matter known as such. In a first step, the corresponding vinyl ester is polymerised by free radical polymerisation in a suitable solvent, usually water or an alcohol such as methanol, ethanol, propanol and/or butanol using a suitable radical initiator. If the polymerisation is carried out in the presence of monomers copolymerisable by free radicals, the corresponding vinyl ester copolymers are obtained.

The vinyl ester (co)polymer is then saponified in a second step, usually by reesterification with methanol, it being possible to adjust the degree of saponification in a controlled manner known as such, e.g. by varying the catalyst concentration, the reaction temperature and/or the reaction time. Regarding further details, reference should be made to the current specialist literature, in particular Ullmann's Encyclopedia of Industrial Chemistry, Fifth Edition on CD-Rom, Wiley-VCH, 1997, keyword: poly(vinyl acetals) and the literature references indicated therein.

The production according to the invention of particularly suitable copolymers is described in European Patent Application EP-1 008 605 A, reference to the disclosure of which is herewith made explicitly.

According to the invention, the viscosity of the polyvinyl alcohols is of secondary importance; basically, both low molecular as well as high molecular polyvinyl alcohols can be used. However, it has proved particularly advantageous within the framework of the present invention for the polyvinyl alcohol to have a viscosity in the region of 2 to 100 mPas, preferably in the region of 2 to 40 mPas, appropriately in the region of 3 to 30 mPas, in particular in the region of 3 to 15 mPas (measured as 4% by wt. aqueous solution according to Hoppler at 20° C., DIN 53015).

Within the framework of the present invention, the plastic moulded body, moreover, exhibits a cover layer which protects the barrier layer in particular against atmospheric humidity, water vapour and water as well as mechanical stress, e.g. in the filling process. Appropriately, it is applied directly onto the barrier layer.

According to the invention, the cover layer comprises compounds which are cross-linkable. Cross-linkable compounds generally comprise at least two, three or more ethylenically unsaturated groups and/or polyaromatic groups. Such compounds are known as such in the world of experts, the reference works Römpp Chemie-Lexikon, second edition, on CD-Rom, 2000 and Ullmann's Encyclopedia of Industrial Chemistry, fifth edition, 1997, for example, providing valuable information.

Cross-linking can in this case take place by radical reactions and/or cycloadditions, for example.

Preferably, the cross-linkable compounds have a high boiling point such that the compounds have a low volatility. Particularly preferably, the boiling point at normal pressure (1023 mbar) is higher than or equal to 80° C., in particular higher than or equal to 100° C. and particularly preferably higher than or equal to 120° C. According to a particularly preferred aspect of the present invention, the cross-linkable compound has a decomposition temperature that is higher than or equal to 200° C. without the compound changing into the gaseous state up to this temperature. The composition of the cover layer preferably exhibits a boiling point at normal pressure (1023 mbar) that is higher than or equal to 80° C., in particular higher than or equal to 100° C. and particularly preferably higher than or equal to 120° C.

The molecular weight of preferred cross-linkable compounds is at least 100 g/mol, preferably at least 200 g/mol.

The proportion of cross-linkable compounds in the cover layer amounts to preferably at least 5% by wt., preferably at least 10% by wt. and particularly preferably at least 50% by wt.

The preferred groups which may be contained in the cross-linkable compounds and which can be converted by radical reactions include ethylenically unsaturated groups which are preferably terminal such as in particular acrylic and/or fumaric and/or maleic groups with the formulae (5) 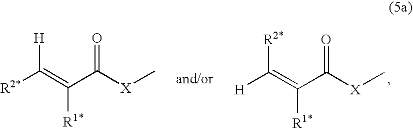
in which the radicals R^{1*} represent, independently in each case, hydrogen and/or an alkyl radical with 1 to 8 carbon atoms, preferably methyl, R^{2*} represent, independently in each case, hydrogen and/or a radical with the formula COOR′, R′ representing hydrogen or an alkyl radical with 1 to 10 carbon atoms, in particular methyl or ethyl, or an aryl radical with 6 to 12 carbon atoms, in particular phenyl or tolyl and X represents independently oxygen, sulphr or a radical with the formula NR″, R″ representing hydrogen or an alkyl radical with 1 to 10 carbon atoms, in particular methyl or ethyl, or an aryl radical with 6 to 12 carbon atoms, in particular phenyl or tolyl.

Preferred groups which may be contained in the cross-linkable compounds and which can be converted by cycloadditions frequently exhibit ethylenically unsaturated groups which are activated. The activated groups include in particular aromatic and/or heteroaromatic groups such as e.g. phenyl radicals, pyridine radicals and/or thioazol radicals. Moreover, the ethylenically unsaturated groups can also be activated by ester radicals. The groups which are cross-linkable by cycloadditions include in particular groups with the formula 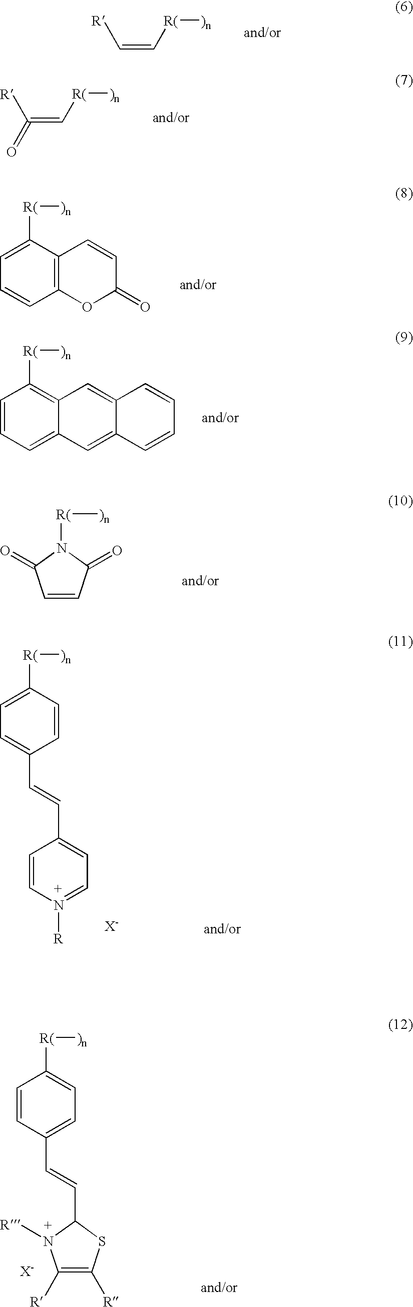
in which
the radical R represents a bond or an at least divalent radical with a molecular weight in the region of 12 to 1,000 g/mole which preferably consists of the optional atoms C, H, O and N, appropriately of the optional atoms C, H and O, in particular of the optional atoms C and H,
n is an integer higher than or equal to 1, in particular in the region of 1 to 4, this number representing the number of bonds through which the groups indicated above are bonded to the radical parts of the cross-linkable compounds,
the radicals R′, R″ or R′″ represent independently hydrogen, an alkyl radical with 1 to 20, in particular 1 to 4 carbon atoms, e.g. methyl or ethyl, and/or an aryl radical with 6 to 24, in particular 6 to 12, carbon atoms, e.g. phenyl or tolyl, and
the group X⁻ represents an anion such as e.g. a halide anion or a sulphate anion.

According to a particular aspect, the radical R represents a trivalent radical, this being preferably derived from an acetal group.

According to a particular aspect of the present invention, the cross-linkable compounds are polymers which exhibit cross-linkable groups.

The preferred polymers include polyvinyl acetals and/or polyacrylates. The weight average of the molecular weight M_{w} of these polymers preferably amounts to 10,000 to 500,000, in particular 20,000 to 150,000. The number average of the molecular weight Mₙ of these polymers is preferably in the region of 5,000 to 400,000, in particular 15,000 to 120,000. The ratio of M_{w}/Mₙ is preferably in the region of 1.0 to 5.0, in particular 1.1 to 4.0. These values can be determined by gel permeation chromatography.

Preferred polyvinyl acetals are derived from the polyvinyl alcohols described above, these exhibiting acetal groups and cross-linkable groups. These polymers can be obtained by conversion of the polyvinyl alcohols described above with compounds (B) with the formula (13) 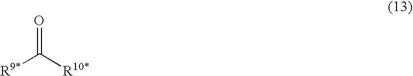
in which R^{9*} and R^{10*} are, independently of each other in each case, hydrogen, COOH, an alkyl group with 1 to 10 carbon atoms or an optionally substituted aryl group with 6 to 12 carbon atoms, as well as compounds with at least one cross-linkable group.

In this connection, these alkyl and aryl radicals can be substituted with one or several carboxyl, hydroxyl, sulphonic acid groups and/or halogen atoms such as fluorine, chlorine, bromine, iodine. The preferred compounds (B) include formaldehyde, acetaldehyde, propionaldehyde, n-butyraldehyde, isobutyraldehyde, 2-ethoxybutyraldehyde, paraldehyde, 1,3,5-trioxan, capronaldehyde, 2-ethyl hexanal, pelargonaldehyde, 3,5,5-trimethyl hexanal, 2-formyl benzoic sulphonic acid, acetone, methyl ethyl ketone, ethyl butyl ketone and/or ethyl hexyl ketone. Within the framework of the present invention, the use of aldehydes, i.e. of compounds with the formula (13) with R^{9*}=hydrogen and/or R^{10*}=hydrogen, a methyl, ethyl, n-propyl or isopropyl group, preferably of formaldehyde or n-butyraldehyde, in particular of n-butyraldehyde, has proved to be particularly suitable.

Basically, the quantities of compound (B) can be chosen at random. Appropriately, between 0.1 and 300 parts by weight, preferably between 25 and 150 parts by weight, appropriately 49 to 99 parts by weight, in particular between 50 and 99 parts by weight of compound (B), based on 100 parts by weight of polymer (A) in each case, are used. Preferably, the degree of acetalisation of the polyvinyl acetals is in the region of 50% to 86.5%, particularly preferably of 70% to 86%, based on all groups derived from vinyl alcohol and present in the starting polymer (in particular hydroxy groups, acetyl groups and ester groups).

Cross-linkable groups can be introduced into the polyvinyl acetals for example by compounds C) which react with the free hydroxy groups of the polyvinyl acetals, these compounds C) preferably exhibiting ethylenically unsaturated and/or polyaromatic groups. These groups which can react with the free hydroxy groups include, among others, N-methylol groups and/or aldehydes groups. The compounds C) which can be reacted with the polyvinyl acetals in order to obtain cross-linkable compounds which can be cross-linked in particular by cycloadditions include in particular aldehydes with the formulae (14) and/or (15). 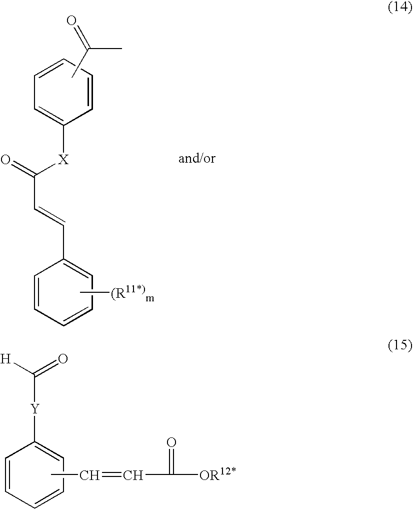
in which the radical R^{11*} is independently selected from alkyl, aryl, alkoxy, —COOR′, —NR″R′″, halogen, cyano and —NH—CO—CH₃, the radicals R′, R″ and R′″ representing independently hydrogen and/or alkyl, preferably with 1 to 20 carbon atoms, the radical R^{12*} representing alkyl, aryl, the index m being an integer in the region of 0 to 3, preferably 0 to 1, the group Y and X being, in each case, a bond or a divalent radical with a molecular weight in the region of 12 to 1,000 g/mole, which preferably consists of the optional atoms C, H, O and N, appropriately of the optional atoms C, H and O, in particular of the optional atoms C and H. Preferably, the radicals R^{11*} and/or R^{12*} comprise 1 to 20, preferably 1 to 6, carbon atoms. Preferred alkyl radicals are methyl and/or ethyl. Preferred alkoxy radicals are methoxy and/or ethoxy. Preferred alkyl radicals are phenyl and/or xylyl.

Preferably, group X is a bond, an oxygen atom and/or a group with the formula —NR^{13*}—Z—, in which Z represents an alkylene or an arylene radical with 1 to 20 carbon atoms and the radical R^{13*} represents hydrogen or an alkyl radical or an aryl radical which preferably exhibits 1 to 20 carbon atoms.

Preferably, group Y is a group with the formula —NH—CO—NR^{14*}—Z— in which Z represents an alkylene or an arylene radical with 1 to 20 carbon atoms and the radical R^{13*} represents hydrogen or an alkyl radical or an aryl radical which preferably exhibits 1 to 20 carbon atoms.

Moreover, compounds C) by means of which in particular groups cross-linkable by radicals can be introduced into the polyvinyl acetals, include the substance (16)

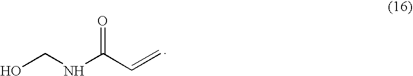

The quantity of compound (C) can basically be selected at random. Appropriately, between 0.1 and 300 parts by weight, preferably between 20 and 70 parts by weight, appropriately 50 to 60 parts by weight of compound (C), based in each case on 100 parts by weight of polymer (A), can be used.

The polyvinyl acetals described above which exhibit cross-linkable groups are described e.g. in patent specifications U.S. Pat. No. 6,596,456 and U.S. Pat. No. 4,965,313.

Polyacrylates can be obtained in particular by the polymerisation of (meth)acrylates which are known as such. Cross-linkable groups can be introduced, e.g. by reesterification reactions, into the polymers of compounds which exhibit hydroxy groups, apart from the cross-linkable groups. Moreover, the polyacrylates can contain comonomers which comprise reactive groups, these groups being capable of reacting with compounds containing cross-linkable groups.

The proportion of groups capable of leading to cross-linking, in the polymers, especially the polyvinyl acetals and/or the polyacrylates, are preferably in the region of 2 mole/mole to 4,000 mole/mole, particularly preferably of 3 mole/mole to 2,500 mole/mole and particularly preferably 15 mole/mole to 2,000 mole/mole. This value relates to the number of groups capable of leading to cross-linking, based on the number of cross-linkable compounds.

According to a particular aspect of the present invention, the cross-linkable compounds preferably have a weight average of the molecular weight in the region 10,000 to 1,000,000 g/mole, in particular in the region of 15,000 to 500,000 g/mole and particularly preferably in the region of 20,000 to 200,000 g/mole. This value can be determined according to gel permeation chromatography.

According to a further embodiment of the present invention, the cover layer is an acrylic composition which contains the following components:
A) 5.0 to 100% by wt., preferably 10.0 to 90.0% by wt., particularly preferably 20.0 to 80.0% by wt., in particular 30.0 to 70.0% by wt., of at least one (meth)acryl-functionalised oligomer or polymer exhibiting at least one group, preferably at least two groups, with the formula (1) 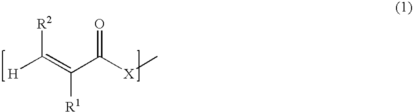
B) 0 to 70% by wt., preferably 20.0 to 60.0% by wt., particularly preferably 30.0 to 50.0% by wt., of at least one (meth)acrylic monomer exhibiting a groups with the formula (1) and
C) 0.0 to 30.0% by wt., preferably 0.1 to 20.0% by wt., in particular 1.0 to 10.0% by wt., of at least one ethylenically unsaturated monomer different from B).

The figures are based, in each case, on the total weight of the acrylic composition and the sum total of the moieties A), B) and C) gives 100.0% by wt. of the polymerisable constituents of the acrylic composition.

Preferably, at least one constituent of the components A) to C) exhibits at least two unsaturated groups.

The radical R¹ indicates hydrogen or a methyl group, preferably hydrogen.

The radical R² is hydrogen or a carboxyl group, preferably hydrogen.

The radical X is oxygen, sulphur and/or a group with the formula NR″ in which the radical R″ represents hydrogen or an alkyl radical with 1 to 10 carbon atoms, in particular methyl or ethyl, or an aryl radical with 6 to 12 carbon atoms, in particular phenyl or tolyl.

Within the framework of the present invention, oligomers and/or polymers indicate compounds which are constructed of one (=homopolymer) or several repeating structural units (=copolymers), the so-called repeating units, and two end groups. Depending on the degree of polymerisation, i.e. depending on the number of times the repeating structural unit reoccurs in the molecule, one talks in this connection of oligomers if the degree of polymerisation is in the region of 2 to 8 or of polymers if the degree of polymerisation is greater than 8. For further details on this subject, reference should be made to the current specialist literature, e.g. to Hand George Elias; Makromoleküle (Macromolecules); Basle, Heidelberg, New York; Hüthig and Wepf; 5^{th} Edition; 1990.

The (meth)acryl—functionalised oligomer or polymer A) can, basically, be derived from any desired oligomer and/or polymer. The type of bonding of the (meth)acrylic group with the formula (1) is, basically, also random; it can take place both to one or both chain ends and to one or several repeating structural units. Oligomers or polymer A), which are particularly suitable according to the invention, are described in the printed document Peter Garrat; Strahlenhättung (Radiation curing); Hanover: Vincentz 1996′, page 71 to 82, to which disclosure explicit reference is made herewith.

Preferably, the (meth)acryl—functionalised oligomer or polymer A) with the formula (17) of (18) 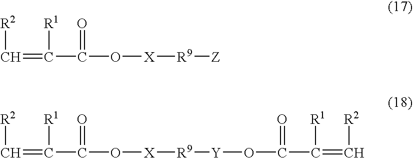
is sufficient
wherein X and Y are, independently of each other in each case, a bond or a divalent radical with a molecular weight in the region of 14 to 1,000 g/mole which, preferably, consists of the optional atoms C, H, O and N, appropriately of the optional atoms C, H and O, in particular of the optional atoms C and H.

Z represents a radical with a molecular weight in the region of 1 to 1,000 g/mole which preferably consists of the optional atoms C, H, O and N, appropriately of the optional atoms C, H and O, in particular of the optional atoms C and H.

R⁹ represents an oligomeric or polymeric radical which is constructed of at least one repeating structural unit (=homopolymer). In the case that R⁹ exhibits several different repeating structural units, the sequence of the structural units (block, random, alternating) is basically random.

Radicals R⁹ which are particularly suitable according to the invention are derived from a polyurethane, a polyether, a polyester or a poly(meth)acrylate.

In this respect, the following compounds have proved to be particularly suitable for the purposes of the present invention: 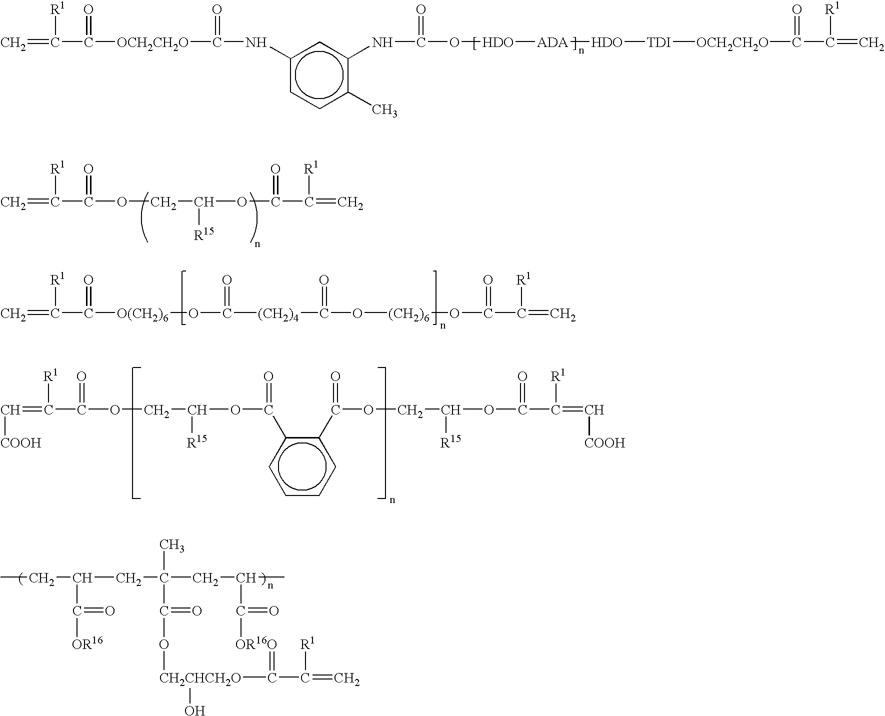
in which R¹⁵ is hydrogen or a methyl group, preferably a methyl group, and R¹⁶ is an aliphatic or cycloaliphatic radical with 1 to 20, preferably 1 to 8, carbon atoms. The index n represents an integer which is greater than or equal to 2, in particular in the region of 2 to 1,000.

The (meth)acrylic monomer B) is different from the (meth)acryl—functionalised oligomer/polymer A). It preferably corresponds to the formula (19) 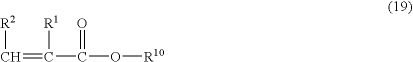
in which the radical R¹⁰ characterises a radical with a molecular weight in the region of 1 to 10.000 g/mole, preferably in the region of 1 to 5.000 g/mole, appropriately in the region of 1 to 1.000 g/mole, in particular in the region of 1 to 500 g/mole. In this respect, R¹⁰ preferably consists of the optional atoms C, H, O and N, appropriately of the optional atoms C, H and O, in particular of the optional atoms C and H. R¹ is preferably hydrogen.

Monomers B) which are particularly suitable for the purposes of the present invention are described in the printed docment Peter Garrat; Strahlenhärtung (Radiation curing); Hanover: Vincentz 1996, page 82 to 94, to the disclosure of which explicit reference is made here.

(Meth)acrylic monomers B) which are particularly suitable according to the invention comprise, among others:

(meth)acrylates derived from saturated alcohols such as methyl(meth)acrylate, ethyl(meth)acrylate, n-propyl (meth)acrylate, isopropyl(meth)acrylate, n-butyl (meth)acrylate, sec-butyl(meth)acrylate, tert-butyl (meth)acrylate, pentyl(meth)acrylate, hexyl (meth)acrylate, heptyl(meth)acrylate, 2-ethylhexyl (meth)acrylate, octyl(meth)acrylate, nonyl(meth)acrylate, isooctyl(meth)acrylate, isononyl(meth)acrylate, 2-tert.-butylheptyl(meth)acrylate, 3-isopropylheptyl (meth)acrylate, decyl(meth)acrylate, undecyl (meth)acrylate, 5-methylundecyl(meth)acrylate, dodecyl (meth)acrylate, 2-methyldodecyl(meth)acrylate, tridecyl (meth)acrylate, 5-methyl tridecyl(meth)acrylate, tetradecyl(meth)acrylate, pentadecyl(meth)acrylate, hexadecyl(meth)acrylate, 2-methylhexadecyl(meth)acrylate, heptadecyl(meth)acrylate, 5-isopropyl heptadecyl (meth)acrylate, 4-tert.-butyloctadecyl(meth)acrylate, 5-ethyloctadecyl(meth)acrylate, 3-isopropyloctadecyl (meth)acrylate, octadecyl(meth)acrylate, nonadecyl (meth)acrylate, eicosyl(meth)acrylate, cetyleicosyl (meth)acrylate, stearyleicosyl(meth)acrylate, docosyl (meth)acrylate, and/or eicosyl tetratriacontyl (meth)acrylate;

cycloalkyl(meth)acrylates, such as cyclopentyl (meth) acrylate, cyclohexyl(meth)acrylate, 3-vinyl-2-butyl cyclohexyl (meth)acrylate, and bornyl(meth)acrylate;

(meth)acrylates which are derived from unsaturated alcohols such as 2-propinyl (meth)acrylate, allyl(meth)acrylate and oleyl (meth)acrylate, vinyl(meth)acrylate;

aryl(meth)acrylates such as benzyl(meth)acrylate or phenyl(meth)acrylate, it being possible for the aryl radicals to be unsubstituted or up to quadrupally substituted, in each case;

hydroxyl alkyl(meth)acrylates such as 3-hydroxypropyl (meth)acrylate, 3,4-dihydroxybutyl (meth)acrylate, 2-hydroxyethyl(meth)acrylate, 2-hydroxypropyl (meth)acrylate, 2,5-dimethyl-1,6-hexane diol (meth)acrylate, 1,10-decane diol(meth)acrylate, 1,2 propane diol(meth)acrylate;

di(meth)acrylates such as 1,2-ethane diol di(meth)acrylate, 1,4-butane diol di(meth)acrylate, 2,2′-thiodiethane diol(meth)acrylate, (thiodiglycol di(meth)acrylate),

aminoalkyl(meth)acrylates such as tris(2-methacryloxyethyl)diamine, N-methylformamidoethyl (meth)acrylate, 2-ureidoethyl(meth)acrylate;

carbonyl—containing (meth)acrylates such as 2-carboxyethyl (meth)acrylate, carboxymethyl(meth)acrylate, oxazolidinyl ethyl (meth)acrylate, N-(methacryloyloxy)formamide, acetonyl(meth)acrylate, N-methacryloyl morpholine, N-methacryloyl-2-pyrrolidinone;

(meth)acrylates of ether alcohols such as tetrahydrofurfuryl(meth)acrylate, vinyloxyethoxyethyl (meth)acrylate, methoxyethoxyethyl(meth)acrylate, 1-butoxypropyl(meth)acrylate, 1-methyl-(2-vinyloxy)ethyl (meth)acrylate, cyclohexyloxymethyl(meth)acrylate, methoxymethoxyethyl(meth)acrylate, benzyloxymethyl (meth)acrylate, furfuryl(meth)acrylate, 2-butoxyethyl (meth)acrylate, 2-ethoxyethoxymethyl (meth)acrylate, 2-ethoxyethyl(meth)acrylate, allyloxymethyl(meth)acrylate, 1-ethoxybutyl(meth)acrylate, methoxymethyl(meth)acrylate, 1-ethoxyethyl(meth)acrylate, ethoxymethyl(meth)acrylate;

(meth)acrylates of halogenated alcohols such as 2,3-dibromopropyl(meth)acrylate, 4-bromophenyl(meth)acrylate, 1,3-dichloro-2-propyl(meth)acrylate, 2-bromoethyl (meth)acrylate, 2-iodoethyl(meth)acrylate, chloromethyl (meth)acrylate;

oxiranyl(meth)acrylates such as 2,3-epoxybutyl (meth)acrylate, 3,4-epoxybutyl(meth)acrylate, glycidyl (meth)acrylate;

heterocyclic(meth)acrylates such as 2-(1-imidazolyl)ethyl (meth)acrylate, 2-(4-morpholinyl)ethyl(meth)acrylate and 1-(2-methacryloyloxyethyl)-2-pyrrolidone;

(meth)acrylates containing phosphorus, boron and/or silicon such as 2-(dimethylphosphato)propyl(meth)acrylate, 2-(ethylene phosphito)propyl(meth)acrylate, dimethylphosphinomethyl(meth)acrylate, dimethyl phosphonoethyl(meth)acrylate, diethyl(meth)acrylol phosphonate, dipropyl(meth)acrylol phosphate;

amides of (meth)acrylic acid such as isobutoxymethyl acrylamide and dimethyl acrylamide;

sulphur-containing (meth)acrylates such as ethylsulfinylethyl(meth)acrylate, 4-thiocyanatobutyl (meth)acrylate, ethylsulfonylethyl(meth)acrylate, thiocyanatomethyl(meth)acrylate, methylsulfinylmethyl (meth)acrylate, bis(meth)acryloyloxyethyl)sulphate;

tri(meth)acrylates such as dimethyloyl propane tri(meth)acrylate, and glycerine tri(meth)acrylate;

According to the invention, the term (meth)acrylates comprises (meth)acrylates and acrylates and mixtures of both. Correspondingly, the term (meth)acrylic acid comprises methacrylic acid and acrylic acid and mixtures of both.

Appropriately, a mixture is used as (meth)acrylic monomer B) which consists of the following components
B-1) 80.0 to 99.9% by wt. of at least one monofunctional (meth)acrylic monomer with exactly one group with the formula (1) per molecule and
B-2) 0.1 to 20.0% by wt. of at least one difunctional and/or polyfunctional (meth)acrylic monomer with at least two groups with the formula (1) per molecule,
   the figures relating to the total weight of the (meth)acrylic monomer B) in each case and the sums of the moieties B-1) and B-2) giving 100.0% by wt.

(Meth)acrylic monomers B-1) which are particularly suitable in this connection and have exactly one group with the formula (1) per molecule comprise 2-ethylhexyl (meth)acrylate, 2-phenoxyethyl(meth)acrylate, n-butyl (meth)acrylate, isodecyl(meth)acrylate, dimethyl aminoethyl(meth)acrylate, isobornyl(meth)acrylate, dicyclopentyl(meth)acrylate, dicyclopentenyloxyethyl (meth)acrylate or mixtures of these compounds.

Particularly suitable difunctional and/or polyfunctional (meth)acrylic monomers B-2) with at least two groups with the formula (1) per molecule comprise pentaerythritol tri(meth)acrylate, trimethylolpropane tri(meth)acrylate, 1,6-hexanediol di(meth)acrylate, trimethylolpropane ethoxylate tri(meth)acrylate, bisphenol-A-ethoxylate di(meth)acrylate, thiodiethylene glycol di(meth)acrylate, tetraethylene glycol di(meth)acrylate, tripropylene glycol di(meth)acrylate, dipropylene glycol di(meth)acrylate, triethylene glycol di(meth)acrylate, trimethylolpropane tri(meth)acrylate, hexadiol di(meth)acrylate, butane diol di(meth)acrylate, 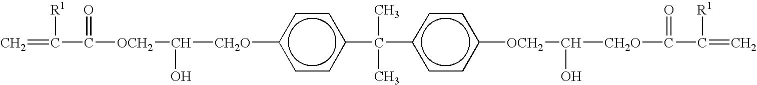
or mixtures of these compounds.

The ethylenically unsaturated monomer C) which is different from A) and B) can, basically, be chosen at random within the framework of the present invention. Preferably, it satisfies the formula (20) 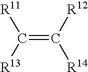
in which R¹¹, R¹², R¹³ and R¹⁴ characterise, independently of each other in each case, a radical with a molecular weight in the region of 1 to 10,000 g/mole, preferably in the region of 1 to 5,000 g/mole, appropriately in the region of 1 to 1,000 g/mole, in particular in the region of 1 to 500 g/mole, which may be bridge-bonded with each other. In this respect, the radicals preferably consist of the optional atoms C, H, O and N, appropriately of the optional atoms C, H and O, in particular of the optional atoms C and H. According to a particularly preferred embodiment of the present invention, R¹¹ and R¹² are hydrogen. According to a further particularly preferred embodiment, R¹³ is hydrogen.

Ethylenically unsaturated monomers C) which are particularly suitable according to the invention comprise, among others:

vinyl halides such as e.g. vinyl chloride, vinyl fluoride, vinylidene chloride and vinylidene fluoride;

vinyl esters such as vinyl acetate;

styrene, substituted styrenes with an alkyl substituent in the side chain such as e.g. α-methylstyrene and α-ethylstyrene, substituted styrenes with an alkyl substituent on the ring such as vinyltoluene and p-methylstyrene, halogenated styrenes such as e.g. monochlorostyrenes, dichlorostyrenes, tribromostyrenes and tetrabromostyrenes;

heterocyclic vinyl compounds such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazol, 3-vinylcarbazol, 4-vinylcarbazol, 1-vinylimidazol, 2-methyl-1-vinylimidazol, N-vinylpyrrolidone, 2-vinylpyrrolidone, N-vinylpyrrolidine, 3-vinylpyrrolidine, N-vinylcaprolactam, N-vinylbutyrolactam, vinyloxolan, vinylfuran, vinylthiophene, vinylthiolan, vinylthiazols and hydrogenated vinylthiazols, vinyloxazols and hydrogenated vinyloxazols;

vinylether and isoprenylether;

maleic acid and maleic acid derivatives such as e.g. monoester and diester of maleic acid, the alcohol radicals exhibiting 1 to 9 carbon atoms,

maleic anhydride, methyl maleic anhydride, maleinimide, methyl maleinimide;

fumaric acid and fumaric acid derivatives such as e.g. monoesters and diesters of fumaric acid, the alcohol radicals exhibiting 1 to 9 carbon atoms;

dienes such as e.g. 1,2-divinylbenzene, 1,3-divinylbenzene, 1,4-divinylbenzene, 1,2-diisopropenylbenzene, 1,3-diisopropenylbenzene and 1,4-diisopropenylbenzene

and mixtures of the above-mentioned compounds.

Ethylenically unsaturated monomers C) which are particularly suitable for the purposes of the present invention comprise vinylacetate, N-vinylpyrrolidone, styrene, isobutoxymethylacrylamide, dimethylacrylamide or mixtures of these compounds.

The ethylenically unsaturated monomer C) comprise in particular ethylenically unsaturated monomers which can be copolymerised with the (meth)acrylic monomers B).

For the initiation of the polymerisation, at least one polymerisation initiator is appropriately added to the composition of the cover layer. Polymerisation initiators which are particularly suitable in this connection comprise in particular the initiators and initiator systems used for radical polymerisation. According to a preferred embodiment of the present invention, lipophilic radical polymerisation initiators are used to initiate the polymerisation. The radical polymerisation initiators are lipophilic in particular so that they dissolve in the composition of the cover layer. Compounds suitable for use include, apart from the conventional azo initiators such as azoisobutiyic acid nitrile (AIBN) or 1,1-azobiscyclohexane carbonitrile, aliphatic peroxy compounds, among others, such as e.g. tert-amyl peroxyneodecanoate, tert.-amyl peroxypivalate, tert.-butyl peroxypivalate, tert.-amyl peroxy-2-ethyl hexanoate, tert.-butyl.peroxy-2-ethyl.hexanoat, tert.-amylperoxy-3,5,5,-trimethyl hexanoate, ethyl-3,3-di-(tert.-amylperoxy) butyrate, tert.-butyl perbenzoate, tert.-butyl hydroperoxide, decanoyl peroxide, lauryl peroxide, benzoyl peroxide and any desired mixtures of the above-mentioned compounds. Among the above-mentioned compounds, AIBN is particularly preferred.

According to a further preferred embodiment of the present invention, the initiation of the polymerisation takes place using known photoinitiators by irradiation with UV radiation or such like. In this connection, the current, commercially available compounds such as e.g. benzophenone, α,α-diethoxyacetone phenone, 4,4-diethylaminobenzophenone, 2,2-dimethoxy-2-phenyl lactophenone, 4-isopropylphenyl-2-hydroxy-2-propyl ketone, 1-hydroxycyclohexylphenyl ketone, isoamyl-p-dimethylaminobenzoate, methyl-4-dimethylaminobenzoate, methyl-o-benzoyl benzoate, benzoin, benzoin ethyl ether, benzoin isopropyl ether, benzoin isobutyl ether, 2-hydroxy-2-methyl-1-1phenylpropane-1-one, 2-isopropylthioxanthone, dibenzosuberone, 2,4,6-trimethylbenzoyl diphenyl phosphine oxide, bisacyl phosphine oxide and others can be used, it being possible to use the above-mentioned photoinitiators as such or in combination of two or more or in combination with one of the above-mentioned polymerisation initiators.

The quantity of radical formers can vary within wide ranges. Preferably, quantities in the region of 0.1 to 10.0% by wt., based on the weight of the total composition of radically polymerisable compounds of the cover layer and polymerisation initiator are used, for example. In particular, quantities in the region of 0.2 to 5.0% by wt., based on the weight of the total composition of radically polymerisable compounds of the cover layer and polymerisation initiator in each case.

If the cross-linkable compounds of the cover layer exhibit groups which react by cycloaddition, the cover layer can also comprise compounds which accelerate this cycloaddition. These include in particular photosensitisers. Such compounds are described in DE-A-26 26 769, DE-42 31 324 and U.S. Pat. No. 5,476,754, among others. These include, among others, xanthones, thioxanthones, acetophenone, benzaldehyde, carbazol, triphenyl amine, hexachlorobenzene, 4,4-diphenylcyclohexadienone, 1,2-dibenzoylbenzene, benzophenone and derivatives thereof, 1,4-diacetylbenzene, fluorene, anthrone, benzanthrone and derivatives thereof, 2-nitrofuorene, 1,4 benzodiazine, 4-nitrobiphenyl, 4-cyanobenzophenone, thioxanthone, phenyl glyoxal, anthraquinone, quinoline, phenantrene, flavone, Michler's ketones, 4-acetyldiphenyl, 2-acetonaphthene, acridine yellow, 1-naphthylphenyl ketone, chrysene, 1-acetonaphthol, 1-naphthaldehyde, coronene, benzil, fluorenone, fluorescein, aromatic nitrogen compounds such as p-nitrostibene, 5-nitroacenaphthene and 4-nitroaniline, naphthothiazoline and derivatives thereof, 1-acetylamino-4-nitronaphthaline, quinones, benzothiazoline derivatives, naphthothiazol derivatives, ketocoumarin derivatives, benzothiazol derivatives, naphthofuranone compounds, benzothiazolines, pyrylium salts and thiapyrylium salts.

The quantity of photosensitisers is preferably in the region of 0.5 to 20% by wt., based on the total cover layer, particularly preferably 1 to 10% by wt.

The cross-linkable compounds of the cover layer can be cured in the known way. The cured cover layer exhibits excellent properties. These include in particular the mechanical properties.

The upper yield point (elongation) of cross-linked moulded bodies obtainable from the compositions of preferred cover layers preferably exhibit a yield point in the region of 1% to 100%, in particular in the region of 3% to 50% and particularly preferably in the region of 6% to 20%.

According to a further preferred embodiment of the present invention, cross-linked moulded bodies obtainable from the compositions of preferred cover layers preferably exhibit an elongation at break in the region of 1% to 100%, in particular in the region of 3% to 50% and particularly preferably in the region of 6% to 20%.

The elongation is obtainable from stress-strain tests according to ISO 527-2 (1996), the measurement being generally carried out at a rate of testing of 50 mm/min.

According to a particular aspect of the present invention, the cross-linked cover layer preferably exhibits a hardness according to ISO 15184 (pencil hardness) at room temperature (23° C.) in the region of 2 to 9 H, in particular in the region of 3 to 8 H and particularly preferably in the region of 4 to 7 H, pencils from Faber-Castell® being preferably used for the measurement.

The mechanical properties are preferably determined in a standard climate according to ISO 291-23/50.

A number of further additives can be added to the composition of the cover layer. These can be additives which are capable of influencing and consequently adjusting the properties of the layer resulting from the composition of the cover layer after curing. In this way, bonding agents or coupling agents which improve the adhesion to the substrate or to other coating cover layers can be added to the composition.

It is also possible to add substances to the composition of the cover layer in order to improve the hardness of the coating or to improve the scratch resistance or for the controlled adjustment of other surface properties.

The quantity of such additives can vary within wide ranges. However, it is generally less than 50% by wt., based on the total weight of the composition of the cover layer. Preferably, it is in the region of 0.1-<50% by wt. Specific ranges comprise 0.5-15% by wt. as well as 16-40% by wt.

According to a particularly preferred embodiment, a UV/E radiation curing cover layer contains additives which improve the adhesion to the substrate and/or the scratch resistance or the elasticity. Suitable additives are polyvinyl acetals and, in this respect in particular, polyvinyl butyrals and polyvinyl acetal copolymers. Polyvinyl butyrals known to the expert can be used as polyvinyl butyrals. In addition, polyvinyl acetals produced from two or more different aldehydes can be used such as e.g. mixtures of butyraldehyde with acetaldehyde and/or formaldehyde. The use of mixtures of polyvinyl acetals (e.g. with different molecular weights, different residual acetate contents, different degrees of acetalisation and/or different acetalisation components (aldehydes)) is also possible. For example, polyvinyl acetals produced from other aldehydes as starting material in each case can be mixed and used. The combination possibilities are unlimited.

Moreover, inorganic and organic additives containing nano particles are suitable. The additives can also consist of inorganic and/or organic hybrid polymers which behave in an inert manner or, during curing of the coating, undergo chemical reactions with each other or with other components of the coating composition. These include in particular inorganic particles which preferably exhibit a size in the region of 10 to 500 nm, particularly preferably in the region of 20 to 200 nm. Such particles can be obtained commercially. In a particularly preferred embodiment, the additive described can also be the main components in a coating composition.

In a further embodiment, the composition of the cover layer contains cross-linkable raw materials which are derived from silanes, silanols and their derivatives. The silicon-containing raw materials can be monomers, oligomers and polymers. The silicon-containing compounds can condense in the presence of water (e.g. by atmospheric humidity after applying the coating) or they cross-link with themselves or with reactants from the composition of the cover layer by thermal, UV/E or redox initiated curing. The compounds may exhibit sizes in the nano meter range and consequently be present in the layer as nano particles. The composition of the cover layer modified with silicon-containing compounds can also contain polyvinyl acetals to improve the adhesion and flexiblisation.

In a further particularly preferred embodiment, the cover layer is produced by a composition which consists to a predominant part of the silicon-containing compounds described above. This composition can also contain polyvinyl acetals to improve the adhesion and flexiblisation.

In a further preferred embodiment, the cover layer contains components which have been formed by chemical or thermal cross-linking of suitable raw materials. Suitable raw materials are monomers, oligomers and polymers which are capable of undergoing cross-linking reactions via reactive atom groups. Particularly suitable are raw materials which have hydroxide groups, carbonyl groups, aldehyde groups, carboxyl groups and nitrogen-containing and silicon-containing groups available in their molecular structure.

According to a particularly preferred embodiment of the present invention, the barrier and/or the cover layer contains at least one dye and/or one pigment. The terms “pigments” and “dyes” are well known to the expert from the literature. “Pigments” indicate inorganic or organic, coloured or non-coloured colouring agents which are practically insoluble in the application medium and “dyes” stand for inorganic or organic, coloured or non-coloured colouring agents soluble in the application medium. Regarding further details, reference should be made to the current literature, e.g. Römpp-Lexikon Chemie; publisher: Jurgen Falbe, Manfred Regitz; Stuttgart, New York; Thieme, 10^{th} Edition 1997; keywords “pigments” and “dyes” and the literature references quoted therein.

Dyes for the barrier layer which are particularly suitable according to the invention comprise water-soluble dyes, in particular the ®Vitasyn dyes such as for example ®Vitasyn Blue AE 90 and ®Vitasyn Tartrazine X 90 from Clariant GmbH. In comparison, water-insoluble dyes, pigments or mixtures of these, in particular the pigment preparation ®Renol HW 30 (Clariant GmbH) and/or ®Savinal dyes (Clariant GmbH) have proved to be particularly suitable for tinting the cover layer. The quantity of dye and/or pigment is preferably in the region of 0.0001 to 20.0% by wt., in particular in the region of 0.01 to 10.0% by wt., based on the total weight of the dyed barrier layer and/or cover layer, in each case.

Tinting of the barrier and/or cover layer of the plastic moulded body is particularly advantageous, among other things, because plastic moulded bodies tinted in this way can be recycled in a simple manner after detaching the dyed barrier and/or cover layer. In contrast, moulded bodies in the case of which the plastic core has been dyed must be sorted and recycled separately in a time-consuming and complex process.

If necessary, the cover layer may contain further additives such as e.g. dispersing agents, waxes, defoaming agents and plasticisers. These are preferably present in a quantity of 10.0% by wt., appropriately of up to 5.0% by wt., in particular in the region of 0.1 to 2.0% by wt., based on the total weight of the cover layer in each case.

The plastic moulded body according to the invention is characterised in particular by a permanent low gas permeability, in particular to carbon dioxide and oxygen. In this respect, the gas barrier effect obtained by the coating can be determined by means of processes known as such. These measurements are usually based either on measuring a pressure increase in the measuring cylinder or on detecting the gas concerned outside the article to be investigated (also in a closed cylinder) by infrared spectroscopy. In comparison with a standard, a factor is thus obtained regarding the improvement in the barrier property which, in the English language, is referred to as barrier improvement factor (BIF). The BIF of an uncoated PET bottle consequently amounts to approximately 1. A BIF of 3 then means that the shelf life of the packaged product (CO₂ loss and oxygen penetration) is three times as long as in the case of an uncoated PET bottle; i.e. it amounts to three (3) months instead of one (1) month.

Apart from the barrier effect e.g. vis-à-vis carbon dioxide and oxygen outwardly, there is, conversely, also a barrier effect from outside. This means that the penetration of oxygen in particular from outside is prevented by the vessel wall. This is particularly important in the case of goods which are (easily) oxidisable and can be damaged by reaction with oxygen which implies the deterioration of the substance introduced. This includes in particular vitamins, aromas and enzymes. In this respect, the barrier is not restricted to only one direction but rather fulfils two functions simultaneously (e.g.: retention of carbon dioxide within the bottle (barrier outwards) and protection against oxidation (oxygen) from outside (barrier from outside)). Consequently, the barrier improvement of the present invention means a longer keeping quality of the substance introduced which is also referred to by the term shelf life. In the case of a BIF of 1, the keeping quality (shelf life) amounts to one month, for example, with a BIF of 2, this time is doubled to two months, with higher BIF values correspondingly longer. These examples apply to carbon dioxide-containing, alcohol-free beverages (colas and lemonades).

In the case of beer, the oxygen barrier—apart from the carbon dioxide barrier—plays an even more important part.

As a rule, the minimum requirements regarding the BIF values are higher, the BIF should usually amount to at least 5. This corresponds to a shelf life of 5 months.

The production of the plastic moulded body according to the invention can take place in a simple and cost-effective manner which is known as such. The use of special time and labour consuming techniques such as e.g. coextrusion or plasma coating, is required. Preferably, the plastic moulded body is first coated with the desired polyvinyl alcohol and then with the composition of the cover layer specified above. In this way, all known coating processes, can, basically, be used even though immersion, spray, casting, atomisation and/or electrostatic spray processes have proved to be particularly suitable.

The barrier layer containing polyvinyl alcohol is preferably applied from an aqueous solution and then preferably dried in the subsequent step. This is advantageous in order to optimise the application of the subsequent layer which is applied, if necessary, from a solvent other than water. In the case of application wet on wet, there is the danger of the layers being mixed which negatively influences the barrier effect, on the one hand, and causes a deterioration of the optical appearance, on the other hand, by causing turbidities. Drying can take place in many different ways. In this respect, it is important that the base material is not changed or even damaged by drying (e.g. by thermal deformation). Apart from (hot) air dryers, infrared or microwave radiation can be used for drying. The best and most advantageous system is based on the requirements regarding the residence times, the rates of throughput, thermal loads and such like. The concentration of the solution used depends on the macroscopic properties thereof in which respect, depending on the system, different optimum ranges exist which represent an optimum at the temperature used. Preferably, the polyvinyl alcohol concentrations are in the region of 1.0 to 30.0% by wt., particularly preferably in the region of 3 to 20% by wt. and in particular in the region of 5 to 15% by wt., based on the total weight of the aqueous solution.

The barrier layer containing polyvinyl alcohol which is fully formed and dried is now able, in a particularly advantageous manner, to receive the next cover layer. However, under certain circumstances, it may be particularly advantageous to increase the adhesion of the cover layer to the barrier layer by a primer.

Preferably, the cover layer is also applied by means of the coating technologies described above, it being possible for the technology chosen for each layer to be different and not having to be the same for both layers. This also depends on the desired requirements which have been described in further detail above. According to a particularly preferred embodiment of the present invention, the composition of the cover layer is applied without using a solvent.

Curing of the cover layer can take place following the initiation of the polymerisation of the composition in a manner known as such, e.g. thermally and/or by redox initiation. According to a particularly preferred embodiment of the present invention, the polymerisation is initiated by UV radiation. Although it is known that, in the case of aqueous polyvinyl alcohol solutions, an irradiation with UV light may lead to a molecular weight degradation, the barrier layer containing polyvinyl alcohol according to the invention is not attacked by the UV radiation used for curing of the cover layer. On the contrary, the high BIF of the coated plastic moulded body is retained in the unchanged state and/or is even slightly increased.

According to a second preferred embodiment of the present invention, the polymerisation is initiated by electron radiation (E-radiation).

The thicknesses of the öayers applied depend on the desired properties. The layer thickness of the barrier layer is preferably in the region of 0.5 to 10 μm, particularly preferably in the region of 1 to 5 μm. The layer thickness of the cover layer is preferably in the region of 0.5 to 10 μm, particularly preferably in the region of 1 to 5 μm. A layer thickness of only 2 μm, in particular of 1 μm, of each individual layer is sufficient to achieve barrier improvement factors of >3 with a simultaneous resistance to water. This means an increase in weight of generally only approximately 0.2 g in the case of an 0.5 PET bottle.

According to a particular aspect of the present invention, a preform is produced which comprises a substrate layer, a barrier layer as well as a cover layer which contains a cross-linkable compound. This preform is subsequently blow moulded to form a plastic body. In a further step, the cover layer of the plastic moulded body is cross-linked.

If preforms are coated, it is advantageous to select the layer thickness initially to be correspondingly higher since the components are stretched during stretch blow moulding. Depending on the desired final layer thickness, i.e. the desired layer thickness of the barrier and the cover layer of the stretch blow-moulded body, the barrier layer and the cover layer should be applied correspondingly more thickly. In these cases, a multiple (repeated) application of the individual components or the use of higher concentrations may be advantageous. Since the preforms are usually not processed immediately in a stretch blow moulding machine, the rate of application of the coatings does not depend on the speed of the filling facility. For this reason, the preforms can also be coated by other techniques such as e.g. dipping.

The composition of the cover layer is preferably homogeneously stretchable; this property is particularly advantageous when coating preforms which, depending on the size of the stretched container, are stretched by a factor of 10. According to a particular aspect of the present invention, the term homogeneously stretchable means that the maximum layer thickness of the non-cross-linked cover layer of a moulded body stretched by a factor of 10 parallel to the coating is preferably maximum 5 μm, particularly preferably maximum 2 μm and particularly preferably maximum 1 μm thicker than the minimum layer thickness. This property is generally achieved by cross-linkable polymers which are highly compatible with the barrier layer. These include in particular the cross-linkable polyvinyl acetals detailed above.

The glass temperature of the composition of the cover layer, in particular the glass temperature of cross-linkable polymers which may be contained in the composition of the cover layer is preferably less than or equal to the processing temperature of the substrate layer. According to a particular aspect, the glass temperature of the composition of the cover layer, in particular the glass temperature of cross-linkable polymers which may be contained in the composition of the cover layer is less than or equal to 120° C., in particular less than or equal to 110° C. and particularly preferably less than or equal lo 100° C. The glass temperature can be determined by differential scanning calorimetry (DSC). This property is particularly advantageous when coating preforms. The glass temperature can be estimated using the Fox equation which applies in approximation, for the purposes of the present invention, to all organic polymers exhibiting cross-linking groups, in particular to polyvinyl acetals and/or acrylic polymers.

The Fox equation is:
1/T_{g}=x₁/T_{g1}+x₂/T_{g2}+x₃/T_{g3}+. . . .
in which
T_{g} is the glass transition temperature of the copolymer,
T_{g1} is the glass transition temperature of a homopolymer produced from the first monomer of the copolymer,
T_{g2} is the glass transition temperature of a homopolymer produced from the second monomer of the copolymer,
T_{g3} is the glass transition temperature of a homopolymer produced from the third monomer of the copolymer,
x₁ is the proportion by weight of the first monomer in the copolymer,
x₂ is the proportion by weight of the second monomer in the copolymer and
x₃ is the proportion by weight of the third monomer in the copolymer.
When using four or more comonomers, the above equation is correspondingly extended. The Fox equation is described in Bull. Am. Phys. Soc. 1, 123 (1956), to which reference is made herewith. The temperature is indicated in Kelvin in this case.

Preferably, the cross-linked cover layers exhibit hardly any decrease in the barrier improvement factor after mechanical stress caused by a filling facility. According to a particular aspect of the present invention, the barrier improvement factor preferably decreases by maximum 20%, in particular by maximum 10% and particularly preferably by maximum 5%, based on the barrier improvement factor before the mechanical stress applied by a filling facility.

The cross-linked cover layer exhibits an excellent scratch resistance. The scratch resistance can be determined by way of the Taber test according to DIN 53754. In this case, the abrasion under a load of 1,000 g using friction rollers of type CS17 and a test device from Taber Industries, model 5131, is preferably less than 30 mg, in particular less than 20 mg, particularly preferably less than 15 mg after 600 cycles. After 300 cycles, the abrasion is preferably less than 12 mg, in particular less than 8 mg. After 1,000 cycles, the abrasion is preferably less than 40 mg, in particular less than 30 mg and particularly preferably less than 25 mg.

Possible fields of application of the plastic moulded body according to the invention are directly obvious to the expert. In particular, it is suitable for storing gas-sensitive substances, in particular carbon dioxide-containing and/or oxidation-sensitive liquids. According to a particularly preferred embodiment of the present invention, the plastic moulded body is used for storing gas-sensitive foodstuffs, appropriately preferably carbon dioxide-containing beverages, in particular beer and beer-containing beverages.

The following example and reference example serves the purpose of illustrating the present invention without the inventive idea being intended to be restricted thereby in any way.

### EXAMPLE 1

Untreated 0.5 litre PET bottles, blow moulded from 28 g PET preforms by conventional processes are initially immersed in an aqueous solution of 5% by wt. of a polyvinyl alcohol (®Mowiol 28-99, Kuraray Specialities Europe GmbH). After separating off the excess material, the bottles are dried for 4 hours at 50° C. in the circulating air drying cupboard. Subsequently, the bottles are coated with a commercial UV hardening compositioning of the cover layer which satisfies the above-mentioned specification and contains no solvent and adheres to the barrier layer containing polyvinyl alcohol (application 0.1 to 0.15 g per bottle). Subsequently, the bottles are exposed to UV light under an oxygen-containing atmosphere for 30 sec (10 cm tube, performance 120 W/cm, Dr. Hönle AG) and thus cured.

The coated PET bottles are then filled with water in a filling facility. After passing through the facility, the bottles are assessed for scratches in the cover layer and subsequently stored for 7 days in water. After storage in water, the quality of the cover layer is accessed. The results are shown in the following table 1.

### COMPARATIVE EXAMPLE 1

Untreated 0.5 litre PET bottles, blow moulded from 28 g PET preforms by conventional processes are initially immersed in an aqueous solution of 5% by wt. of a polyvinyl alcohol (®Mowiol 28-99, Kuraray Specialities Europe GmbH). After separating off the excess material, the bottles are dried for 4 hours at 50° C. in the circulating air drying cabin 5 by wt. polyvinyl butyral solution (®Mowital B30 H, Kuraray Specialities Europe GmbH). Then drying is again carried out in the drying cabinet at 50° C.

The coated PET bottles are then filled with water in a filling facility. After passing through the facility, the bottles are assessed for scratches in the cover layer and subsequently stored for 7 days in water. After storage in water, the quality of the cover layer is accessed. The results are shown in the following table 1.

Table 1: Surface quality of the cover layer of different 0.5 litre PET bottles before and after storage in water

| | | |
|---|---|---|
| Sample | Surface quality of | Surface quality of |
| | the cover layer | the cover layer |
| | before storage in | before storage in |
| | water | water |
| Example | The cover layer | No differences to |
| | shows no traces of | the appearance |
| | scratching | before storage in |
| | | water can be |
| | | observed |
| Comparative example | The cover layer | The cover layer has |
| | exhibits scratches | become partially |
| | in the lower third | detached. The layer |
| | of the bottle and | containing |
| | at the bottom | underneath has |
| | | largely dissolved |
| | | polyvinyl alcohol. |

### EXAMPLE 2

Production of polyvinyl butyral comprising cross-linkable groups according to U.S. Pat. No. 4,965,313 1,000 g of polyvinyl butyral (Mowital® B 60 T) are suspended in 1.8 l of deionised water. 1 l of a solution containing 2 g of 85% phosphoric acid, 6 g of hydroquinone monomethyl ether and 300 g of N-hydroxymethyl acrylamide are added to this suspension with constant stirring. This suspension is stirred for a further 30 minutes and subsequently filtered. The solid obtained in this way is subsequently dried at 50° C. for 10 h. For purification, the raw product is repeatedly washed with water and dried again.

Use of the polyvinyl butyral comprising cross-linkable groups for the production of a cover layer.

10 g of the polyvinyl butyral comprising cross-linkable groups are dissolved in 90 g of ethanol. 400 mg of a photoinitiator (Irgacure® 184-Ciba) are added to this solution. This solution is applied onto the substrate containing the barrier layer which substrate comprises the components according to example 1. After drying and removing the solvent, curing by UV radiation (Hg medium pressure irradiator/performance 120 W) takes places for 2 minutes.

### COMPARATIVE EXAMPLE 2

Example 2 was essentially repeated, though Mowital® B 60 T was used instead of the modified polymer.

The substrate provided with a cover layer was subjected to a Taber test, the test being carried out with a load of 1,000 g using friction rollers of type CS17 and a test device from Taber Industries, model 5131. The abrasion was determined after 100, 300, 600, 800 and 1,000 cycles. The results obtained are reproduced in table 1.

### EXAMPLE 3

Example 2 was essentially repeated, though benzophenone (Darocur®-Ciba) was used instead of Irgacure® 184 (Ciba).

The substrate provided with a cover layer was subjected to a Taber test, the test being carried out with a load of 1,000 g using friction rollers of type CS17 and a test device from Taber Industries, model 5131. The abrasion was determined after 100, 300, 600, 800 and 1,000 cycles. The results obtained are reproduced in table 1.

### EXAMPLE 4

Example 2 was essentially repeated, though Irgacure® 500 (Ciba) was used instead of Irgacure® 184 (Ciba).

### EXAMPLE 5

Example 2 was essentially repeated, though Irgacure® 2959 (Ciba) was used instead of Irgacure® 184 (Ciba).

### EXAMPLE 6

Example 2 was essentially repeated, though Darocur® 1173 (Ciba) was used instead of Irgacure® 184 (Ciba).

### EXAMPLE 7

10 g of the polyvinyl butyral comprising cross-linkable groups according to example 2 and 10 g of TPGDA (tripropylene glycol diacrylate) are dissolved in 80 g of ethanol. 400 mg of a photoinitiator (Irgacure® 184-Ciba) are added to this solution. This solution is applied to the substrate containing the barrier layer which comprises the component according to example 1. After drying and removing the solvent, curing by UV radiation (Hg medium pressure irradiator/performance 120 W) takes place for 2 minutes.

The substrate provided with a cover layer was subjected to a Taber test, the test being carried out with a load of 1,000 g using friction rollers of type CS17 and a test device from Taber Industries, model 5131. The abrasion was determined after 100, 300, 600, 800 and 1,000 cycles. The results obtained are reproduced in table 1.

### EXAMPLE 8

Example 7 was essentially repeated although TPGDA (dipropylene glycol diacrylate) which is cross-linkable was used instead of TPGDA.

### EXAMPLE 9

Example 7 was essentially repeated although a trifunctional acrylate—TMPTA (trimethylol propane triacrylate)—was used instead of TPGDA for additional cross-linking.

### EXAMPLE 10

Example 7 was essentially repeated although a pentafunctional acrylate—DPPA (dipentaerythritol pentaacrylate)—was used instead of TPGDA for additional cross-linking.

### EXAMPLE 11

Example 7 was essentially repeated although DPHA (dipentaerythritol hexaacrylate)—was used instead of TPGDA for additional cross-linking.

### EXAMPLE 12

10 g of the polyvinyl butyral comprising cross-linkable groups according to example 2 and 9.5 g of TPGDA (tripropylene glycol diacrylate) and 0.5 g DPHA (dipentaerythritol hexaacrylate) are dissolved in 80 g of ethanol. 400 mg of a photoinitiator (Irgacure® 184-Ciba) are added to this solution. This solution is applied to the substrate containing the barrier layer which comprises the component according to example 1. After drying and removing the solvent, curing by UV radiation (Hg medium pressure irradiator/performance 120 W) takes place for 2 minutes.

The substrate provided with a cover layer was subjected to a Taber test, the test being carried out with a load of 1,000 g using friction rollers of type CS17 and a test device from Taber Industries, model 5131. The abrasion was determined after 100, 300, 600, 800 and 1,000 cycles. The results obtained are reproduced in table 1.

TABLE 1

| | Reference | | | |
|---|---|---|---|---|
| | Example 2 | Example 3 | Example 7 | Example 12 |
| Number of | Abrasion | Abrasion | Abrasion | Abrasion |
| cycles | [mg] | [mg] | [mg] | [mg] |
| 0 | 0 | 0 | 0 | 0 |
| 100 | 7 | 4 | 3 | 2 |
| 300 | 19 | 10 | 8 | 7 |
| 600 | 36 | 21 | 17 | 13 |
| 800 | 47 | 29 | 22 | 18 |
| 1,000 | 60 | 35 | 28 | 22 |

1. Plastic bottle or preform for a plastic bottle for storing carbon dioxide-containing and/or oxidation-sensitive liquids exhibiting a substrate layer, a barrier layer and a cover layer, the barrier layer containing polyvinyl alcohol with a viscosity in the region of 2 to 100 mPas, measured as 4% by wt. aqueous solution according to Höppler at 20° C., DIN 53015), characterised in that the cover layer comprises compounds which are cross-linkable.

2. Plastic bottle or preform for a plastic bottle according to claim 1 characterised in that the cover layer comprises at least 10% by wt. of compounds which are cross-linkable.

3. Plastic bottle or preform for a plastic bottle according to claim 1 characterised in that the compounds are cross-linkable by UV radiation.

4. Plastic bottle or preform for a plastic bottle according to claim 1 characterised in that the cross-linkable compounds have a boiling point at normal pressure (1023 mbar) higher than or equal 120° C.

5. Plastic bottle or preform for a plastic bottle according to claim 1 characterised in that the cross-linkable compounds have a molecular weight of more than 100 g/mole.

6. Plastic bottle or preform for a plastic bottle according to claim 1 characterised in that the cross-linkable compounds comprise groups with the formula 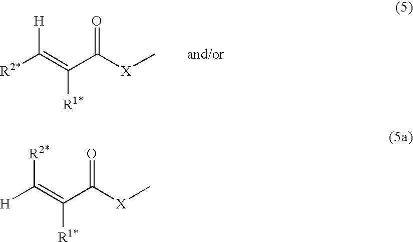
in which the radicals R^{1*} represent, independently in each case, hydrogen and/or an alkyl radical with 1 to 8 carbon atoms, preferably methyl, R^{2*} represent, independently in each case, hydrogen and/or a radical with the formula COOR′, R′ representing hydrogen or an alkyl radical with 1 to 10 carbon atoms or an aryl radical with 6 to 12 carbon atoms and X represents independently oxygen, sulphur or a radical with the formula NR″, R″ representing hydrogen, an alkyl radical with 1 to 10 carbon atoms or an aryl radical with 6 to 12 carbon atoms.

7. Plastic bottle or preform for a plastic bottle according to claim 1 characterised in that the cross-linkable compounds comprise groups with the formula 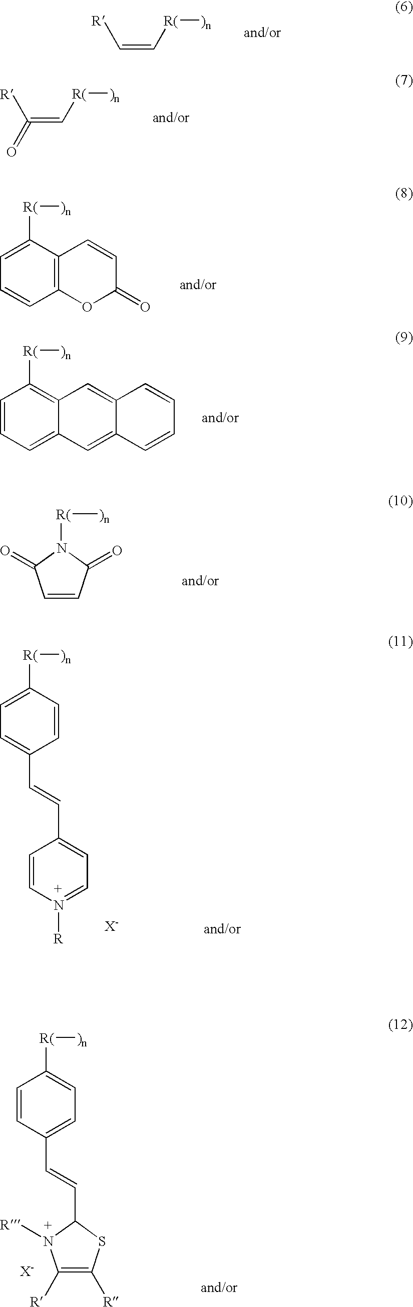
in which
the radical R represents a bond or an at least divalent radical with a molecular weight in the region of 12 to 1,000 g/mole, n represents an integer higher than or equal 1, the radicals R′, R″ or R′″ represent independently hydrogen, an alkyl radical with 1 to 20, in particular 1 to 4 carbon atoms, e.g. methyl or ethyl and/or an aryl radical with 6 to 24, in particular 6 to 12, carbon atoms, e.g. phenyl or tolyl and the group X represents anion.

8. Plastic bottle or preform for a plastic bottle according to claim 1 characterised in that the cross-linkable compounds are derived from acrylic compounds and/or polyvinyl acetals.

9. Plastic bottle or preform for a plastic bottle according to claim 1 characterised in that the moulded body contains, based on its total weight, at least 80% by wt. of polyethylene terephthalate.

10. Plastic bottle or preform for a plastic bottle according to claim 1 characterised in that the Plastic bottle or preform for a plastic bottle is a preform for plastic containers.

11. Plastic bottle or preform for a plastic bottle according to claim 1 characterised in that the polyvinyl alcohol comprises
a.) 15.0 to 99.9% by wt. of structural units with the formula (2) 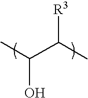
in which R³ represents hydrogen or methyl,
b.) 0.0 to 50.0% by wt. of structural units with the formula (3) 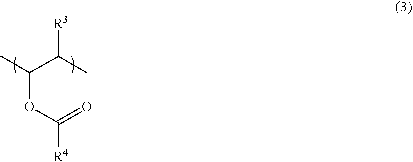
in which R⁴ represents an alkyl radical with 1 to 6 carbon atoms
c.) 0.0 to 50.0% by wt. of structural units with the formula (4) 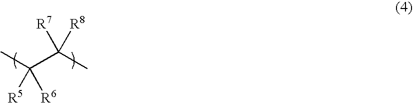
in which R⁵, R⁶, R⁷ and R⁸ are, independently of each other in each case, radicals with a molecular weight in the region of 1 to 500 g/mole, based on the total weight of the polyvinyl alcohol in each case.

12. Plastic bottle or preform for a plastic bottle according to claim 11 characterised in that the polyvinyl alcohol is an ethylene-vinyl alcohol-copolymer which, based on the content of structural units with the formula (2), (3) and (4) in each case, contains 1 to 19% by mole structural units with the formula (4) with R⁵, R⁶, R⁷ and R⁸ equal hydrogen and 75 to 99% by mole structural units with the formula (2) with R³ equal hydrogen.

13. Plastic bottle or preform for a plastic bottle according to claim 11 characterised in that, based on the total number of structural units with the formula (2) and (3), the total number of structural units with the formula (3) is less than 20% by mole.

14. Plastic bottle or preform for a plastic bottle exhibiting a substrate layer, a barrier layer and a cover layer, the barrier layer containing polyvinyl alcohol, characterised in that the cover layer comprises an acrylic composition which contains the following components:
A) 5 to 100% by wt. of at least one (meth)acryl-functionalised oligomer or polymer exhibiting at least one group with the formula (1) 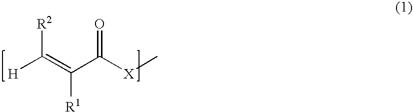
in which R¹ is hydrogen or a methyl group, R² hydrogen or a carboxyl group, X oxygen, sulphur and/or a group with the formula NR″, the radical R″ representing hydrogen or an alkyl radical with 1 to 10 n carbon atoms or an aryl radical with 6 to 12 carbon atoms,
B) 0.0 to 70.0% by wt. of at least one (meth)acrylic monomer exhibiting at least one group with the formula (1) and
C) 0.0 to 30.0% by wt. of at least one ethylenically unsaturated monomer different from B)
the figures relating to the total weight of the acrylic composition in each case and the sum total of the moieties A), B) and C) giving 100.0% by wt.

15. Plastic bottle or preform for a plastic bottle according to claim 14 characterised in that at least one compound of the components A) to C) exhibits two ethylenically unsaturated groups.

16. Plastic bottle or preform for a plastic bottle according to claim 14 characterised in that the (meth)acryl-functionalised oligomer/polymer A) is a compound with the formula (17) or (18) 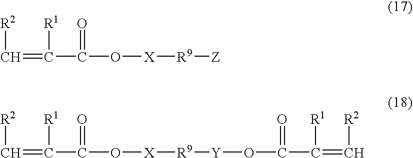
in which X and Y, independently of each other in each case, are a bond or a divalent radical with a molecular weight in the region of 14 to 1,000 g/mole, Z indicate a radical with a molecular weight in the region of 1 to 1,000 g/mole and in which R⁹ represents an oligomeric or polymeric radical which is constructed of at least one repeating structural unit.

17. Plastic bottle or preform for a plastic bottle according to claim 16 characterised in that R⁹ is derived from a polyurethane, polyether, a polyester or a poly(meth)acrylate.

18. Plastic bottle or preform for a plastic bottle according to claim 14 characterised in that at least one (meth)acrylic monomer B) with the formula (19) satisfies 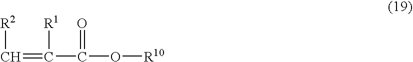
in which the radical R¹⁰ characterises a radical with a molecular weight in the region of 1 to 10,000 g/mole.

19. Plastic bottle or preform for a plastic bottle according to claim 14 characterised in that the (meth)acrylic monomer B) consists of a mixture which contains
B-1) 80.0 to 99.9% by wt. of at least one monofunctional(meth)acrylic monomer with exactly one group with the formula (1) per molecule and
B-2) 0. 1 to 20.0% by wt. of at least one difunctional and/or polyfunctional(meth)acrylic monomer with at least two groups with the formula (1) per molecule
the figures relating case to the total weight of the (meth)acrylic monomer B) in each and the sum total of the moieties B-1) and B-2) giving 100.0% by wt.

20. Plastic bottle or preform for a plastic bottle according to claim 1 characterised in that the barrier and/or cover layer exhibits at least one pigment and/or at least one dye.

21. Plastic bottle or preform for a plastic bottle according to claim 1 characterised in that the barrier and/or cover layer exhibits at least one polyvinyl acetal.

22. Plastic bottle or preform for a plastic bottle according to claim 1 characterised in that the barrier and/or cover layer exhibits cross-linkable and/or cross-linked particles based on silicon (nano particles).

23. Plastic bottle or preform for a plastic bottle obtainable by cross-linking the cross-linkable compounds of the cover layer of a Plastic bottle or preform for a plastic bottle of claim 1.

24. Plastic bottle or preform for a plastic bottle according to claim 23 characterised in that cross-linkable compounds of the cover layer exhibit a glass transition temperature according to DSC of less than 120° C.

25. Plastic bottle or preform for a plastic bottle according to claim 23 characterised in that cover layer exhibits an abrasion according to the Taber test DIN 53754 of less than 30 mg after 600 cycles.

26. Plastic bottle or preform for a plastic bottle according to claim 23 characterised in that the cover layer exhibits a thickness in the region of 1 to 5 μm.

27. Plastic bottle or preform for a plastic bottle according to claim 23 characterised in that the barrier layer exhibits a thickness in the region of 1 to 5 μm.

28. Process for the production of a Plastic bottle or preform for a plastic bottle according to claim 1 characterised in that a plastic moulded body is first coated with a polyvinyl alcohol and then with a coating composition which comprises at least one cross-linkable compound.

29. Process according to claim 28 characterised in that the Plastic bottle or preform for a plastic bottle is coated by immersion, spraying, casting, atomising and/or electrostatic spraying.

30. Use of a Plastic bottle or preform for a plastic bottle according to claim 1 for storing carbon dioxide-containing and/or oxidation-sensitive liquids.
